(19) United States
(12) Patent Application Publication
(10) Pub. No.: US 2018/0321977 A1
(43) Pub. Date: Nov. 8, 2018

(54) FAULT REPRESENTATION OF COMPUTING INFRASTRUCTURES

(71) Applicant: HEWLETT PACKARD ENTERPRISE DEVELOPMENT LP, Houston, TX (US)

(72) Inventors: David A. Moore, Houston, TX (US); Zhikui Wang, Palo Alto, CA (US); Charles W. Cochran, Houston, TX (US); Tahir Cader, Houston, TX (US); Andrew Brown, Houston, TX (US); John P. Franz, Houston, TX (US); Christopher L. Holmes, Houston, TX (US)

(21) Appl. No.: 15/772,348

(22) PCT Filed: Oct. 30, 2015
(86) PCT No.: PCT/US2015/058447

§ 371 Date: Apr. 30, 2018

(51) Int. Cl. G06F 9/50; G06F 11/07

(52) U.S. Cl. CPC G06F 9/505; G06F 11/0793; G06F 11/079; G06F 11/0751

(57) ABSTRACT

In one example, a system for fault representation of computing infrastructures includes an infrastructure engine to determine a fault relationship between a first element and a second element within a computing infrastructure, wherein the fault relationship represents an ability of the first element and the second element to function, a representation engine to generate a fault representation of the computing infrastructure based on the determined fault relationship between the first element and the second element within the computing infrastructure, and a workload engine to assign workloads to the computing infrastructure based on the fault representation of the computing infrastructure.

### BACKGROUND

Computing systems can utilize hardware, software, and/or logic to execute a number of workloads. The computing systems can have complex physical and virtual architectures to execute the number of workloads. The computing systems can rely on a functionality of the physical and virtual architectures to execute the workloads. That is, when one or more elements of the physical or virtual architectures fail, the computing system may fail to execute the number of workloads.

### BRIEF DESCRIPTION OF THE DRAWINGS

FIG. 1 illustrates a diagram of an example of a system for fault representation of computing infrastructures consistent with the present disclosure.

FIG. 2 illustrates a diagram of an example computing device for fault representation of computing infrastructures consistent with the present disclosure.

FIG. 3 illustrates a diagram of an example display of a fault representation of a computing infrastructure consistent with the present disclosure.

FIG. 4 illustrates a diagram of an example display of a fault representation of a computing infrastructure consistent with the present disclosure.

FIG. 5 illustrates a flow chart of an example of a method for environment discovery for fault representation of computing infrastructures consistent with the present disclosure.

FIG. 6 illustrates a flow chart of an example of a method for infrastructure discovery for fault representation of computing infrastructures consistent with the present disclosure.

FIG. 7 illustrates a flow chart of an example of a method for node health discovery for fault representation of computing infrastructures consistent with the present disclosure.

FIG. 8 illustrates a flow chart of an example of a method for node relationship discovery for fault representation of computing infrastructures consistent with the present disclosure.

FIG. 9 illustrates a flow chart of an example of a method for fault representation of computing infrastructures consistent with the present disclosure.

### DETAILED DESCRIPTION

A number of examples for fault representation of computing infrastructures are described herein. In some examples, the fault representation of computing infrastructures can include a visual representation of a computing system. For example, the fault representation of a computing infrastructure can display a data tree visual representation of a workload and a corresponding infrastructure that is capable of executing the workload. In some examples, the workload can be a root node of the data tree visual representation with physical and virtual elements of the computing infrastructure included as child nodes (e.g., leaves, etc.) of the workload based on a relationship (e.g., ability of one element to affect another element, etc.) with the workload. The fault representation of computing infrastructures can be utilized determine reliable hardware for placing workloads. As described further herein, the fault representation can utilize relationships between a plurality of elements within a computing infrastructure to provide a health score to each element.

The fault representation can be generated and/or updated automatically through a number of discovery processes described herein. The number of discovery processes can be utilized to determine physical hardware and/or virtual machines of a server or plurality of servers that can execute the load. In some examples, the number of discovery processes can be performed on a particular schedule and/or in reaction to a particular event (e.g., adding hardware, removing hardware, software update, etc.).

The fault representation can be utilized to display a detailed system architecture that is executing or is intended to execute a particular workload. In some examples, the fault representation can include a risk score (e.g., health score, etc.) associated with each element of the fault representation. The risk score can include a value that represents a likelihood that an element may fail during operation. In some examples, the risk score of a first element may affect a risk score of a second element that includes a relationship (e.g., fault relationship) with the first element. That is, the first element has a fault relationship with the second element where the performance of the first element can affect the performance of the second element. For example, when the first element fails the second element may not function or not function to the specification of the second element.

In some examples, the fault representation can be utilized to determine a computing system to execute the workload. For example, the fault representation can be utilized to determine a computing system that has a greater probability for executing the workload without a failure or malfunction of the computing system. Thus, the fault representation can provide a risk score of the computing system that represents a likelihood that the computing system can execute the workload without having a malfunction. This can be advantageous for users to determine a particular computing system for executing a workload without a malfunction.

In some examples, the fault representation can include a representation of the infrastructure health and not just the health of individual elements of the computing system. For example, the health of a first element of the fault representation can be based on the health of other elements that have a relationship with the first element. Thus, in some examples, the fault representation can provide an infrastructure health of a multi-rack system (e.g., cluster, row, room full of servers, etc.), which can provide valuable information for determining reliable hardware for executing a workload. That is, a reliability score of compute nodes, based on their infrastructure health, can be used to choose the most reliable hardware to place workloads.

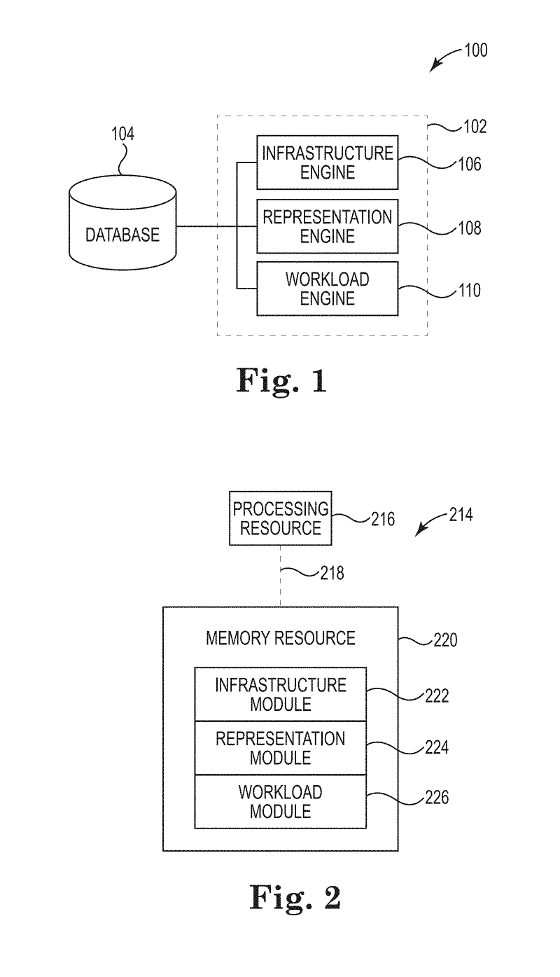

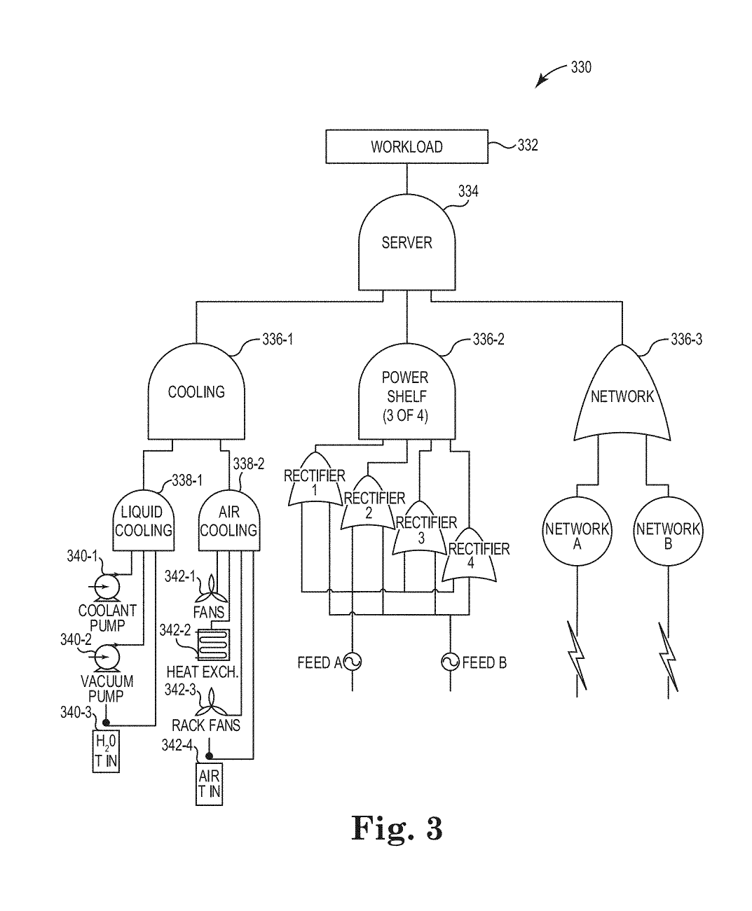

FIGS. 1 and 2 illustrate examples of system and computing device 214 consistent with the present disclosure. FIG. 1 illustrates a diagram of an example of a system for fault representation of computing infrastructures consistent with the present disclosure. The system can include a database 104, a fault representation system 102, and/or a number of engines (e.g., infrastructure engine 106, representation engine 108, workload engine 110). The fault representation system 102 can be in communication with the database 104 via a communication link, and can include the number of engines (e.g., infrastructure engine 106, representation engine 108, workload engine 110). The fault representation system 102 can include additional or fewer engines than are illustrated to perform the various functions as will be described in further detail in connection with FIGS. 3-9.

The number of engines (e.g., infrastructure engine 106, representation engine 108, workload engine 110) can include a combination of hardware and programming, but at least hardware, that is configured to perform functions described herein (e.g., determine a fault relationship between a first element and a second element within a computing infrastructure, wherein the fault relationship represents an ability of the first element and the second element to function, generate a fault representation of the computing infrastructure based on the determined fault relationship between the first element and the second element within the computing infrastructure, assign workloads to the computing infrastructure based on the fault representation of the computing infrastructure, etc.) stored in a memory resource (e.g., computer readable medium, machine readable medium, etc.) as well as hard-wired program (e.g., logic).

The infrastructure engine 106 can include hardware and/or a combination of hardware and programming, but at least hardware, to determine a fault relationship between a first element and a second element within a computing infrastructure, wherein the fault relationship represents an ability of the first element and the second element to function. As used herein, the fault relationship can include a fault dependency between the first element and the second element. That is, the fault relationship can represent how a fault of one element affects a fault of a different element. For example, a fault relationship can exist between a coolant pump and a cooling system that includes liquid and air cooling elements. In this example, a failure of the coolant pump can cause a failure of the cooling system or make the cooling system less reliable since an additional failure or lowered performance of an air cooling element may cause the cooling system to be in a state that is unable to provide proper cooling to the computing system.

In some examples, determining a fault relationship between the first element and the second element can include identifying the first element and the second element within the computing infrastructure via a number of discovery processes described herein. Discovering the elements that make up the computing infrastructure automatically can be advantageous for systems with complex infrastructures and/or systems that have updates performed on the computing infrastructure. In some examples, the elements that are discovered for the computing infrastructure include elements that comprise a support infrastructure. As used herein, the support infrastructure can include elements that support a computing server. For example, the support infrastructure can include, but is not limited to: a cooling system, a power system, and a network system. Thus, the support infrastructure can include elements of the computing system that do not directly execute the workload, but without the support infrastructure the computing system may not be able to properly execute the workload. For example, a malfunction of the cooling system can allow the computing system to overheat and/or fail due to damage caused by excessive heat.

The representation engine 108 can include hardware and/or a combination of hardware and programming, but at least hardware, to generate a fault representation of the computing infrastructure based on the determined fault relationship between the first element and the second element within the computing infrastructure. Generating the fault representation can include generating a data tree structure that represents the determined fault relationships between the first element and the second element. In some examples, the data tree structure can utilize a workload or a computing system as a root node with a plurality of supporting infrastructure elements positioned in the data tree based on the determined relationships between the supporting infrastructure elements and the computing system or workload.

In some examples, generating the fault representation can include generating a directional graph representation for each of a plurality of supporting infrastructures (e.g., IT resource network, power supply network, cooling supply network, management network, etc.). In some examples, each of the directional graph representations can be combined to generate a fault representation that includes the plurality of supporting infrastructures in a single fault representation based on the determined fault relationships between each of the plurality of elements within each of the plurality of supporting infrastructures.

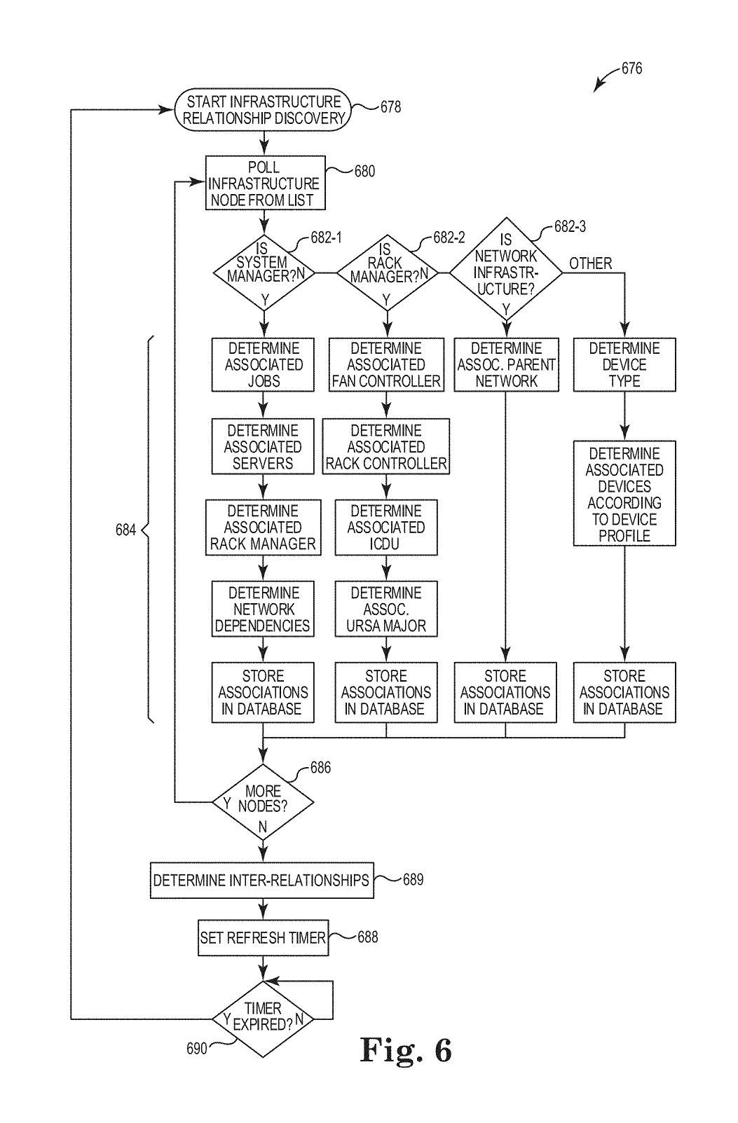

In a specific example, three directional graph representations can be generated for each of an It network, a power supply network, and a cooling supply network. In this example, each of the components for each of the three directional graph representations can include component data that can represent a resource flow or supply-demand relationship with other components within the three directional graph representations. In some examples, the resource flow or supply-demand relationships can be determined by a number of methods described herein (e.g., method 676 as referenced in FIG. 6, etc.). In some examples, the resource flow or supply-demand relationships can include direct relationships (e.g., physically connected, etc.) or implicit relationships (e.g., not directly connected, but have an effect on other devices, etc.).

In this specific example, each of the components can be combined into a fault representation as described herein. The fault representation can include a path or connection between components to display the resource flow or supply-demand relationships. In some examples, all of the components may not be accessible through the fault representation, however, the fault representation can be configured manually or automatically through additional methods as described herein.

The workload engine 110 can include hardware and/or a combination of hardware and programming, but at least hardware, to assign workloads to the computing infrastructure based on the fault representation of the computing infrastructure. In some examples, the fault representation can be utilized to assign and/or reassign workloads based on the fault representation of the computing infrastructure. For example, a fault representation of a first computing infrastructure can be compared to a fault representation of a second computing infrastructure to determine which computing infrastructure has a better overall risk score (e.g., risk score of the computing system based on a risk score associated with each element of the computing infrastructure, etc.). In some examples, the fault representation can be utilized to determine that elements of the computing infrastructure need maintenance and that workloads can be reassigned to other computing systems.

FIG. 2 illustrates a diagram of an example computing device 214 consistent with the present disclosure. The computing device 214 can utilize software, hardware, firmware, and/or logic to perform functions described herein.

The computing device 214 can be any combination of hardware and program instructions configured to share information. The hardware, for example, can include a processing resource 216 and/or a memory resource 220 (e.g., computer-readable medium (CRM), machine readable medium (MRM), database, etc.). A processing resource 216, as used herein, can include any number of processors capable of executing instructions stored by a memory resource 220. Processing resource 216 may be implemented in a single device or distributed across multiple devices. The program instructions (e.g., computer readable instructions (CRI)) can include instructions stored on the memory resource 220 and executable by the processing resource 216 to implement a function (e.g., determine a support infrastructure for a computing system that includes a number of elements that are utilized to provide functionality to the computing system, generate a visual representation of a fault representation that includes the computing system connected to each of the number of elements based on how the number elements provide functionality to the computing system, assign workloads to the computing system based on the fault representation, etc.).

The memory resource 220 can be in communication with a processing resource 216. A memory resource 220, as used herein, can include any number of memory components capable of storing instructions that can be executed by processing resource 216. Such memory resource 220 can be a non-transitory CRM or MRM. Memory resource 220 may be integrated in a single device or distributed across multiple devices. Further, memory resource 220 may be fully or partially integrated in the same device as processing resource 216 or it may be separate but accessible to that device and processing resource 216. Thus, it is noted that the computing device 214 may be implemented on a participant device, on a server device, on a collection of server devices, and/or a combination of the participant device and the server device.

The memory resource 220 can be in communication with the processing resource 216 via a communication link (e.g., a path) 218. The communication link 218 can be local or remote to a machine (e.g., a computing device) associated with the processing resource 216. Examples of a local communication link 218 can include an electronic bus internal to a machine (e.g., a computing device) where the memory resource 220 is one of volatile, non-volatile, fixed, and/or removable storage medium in communication with the processing resource 216 via the electronic bus.

A number of modules (e.g., infrastructure module 222, representation module 224, workload module 226) can include CRI that when executed by the processing resource 216 can perform functions. The number of modules (e.g., infrastructure module 222, representation module 224, workload module 226) can be sub-modules of other modules. For example, the infrastructure module 222 and the representation module 224 can be sub-modules and/or contained within the same computing device. In another example, the number of modules (e.g., infrastructure module 222, representation module 224, workload module 226) can comprise individual modules at separate and distinct locations (e.g., CRM, etc.).

Each of the number of modules (e.g., infrastructure module 222, representation module 224, workload module 226) can include instructions that when executed by the processing resource 216 can function as a corresponding engine as described herein. For example, the infrastructure module 222 can include instructions that when executed by the processing resource 216 can function as the infrastructure engine 106.

FIG. 3 illustrates a diagram of an example display of a fault representation 330 of a computing infrastructure consistent with the present disclosure. In some examples, the fault representation 330 can be organized as a data fault tree based on discovered elements of a computing infrastructure. In some examples, the fault representation 330 can be generated based on a workload 332 and/or computing device such as a server 334 that executes the workload 332. In some examples, the fault representation 330 can be based on discovered infrastructure that supports the server 334.

The infrastructure can include a number of elements that support the server 334. For example, the infrastructure can include a number of systems such as a cooling system 336-1, a power shelf 336-2, and/or a network system 336-3. In this example, the infrastructure elements can help support the server 334 when executing a workload 332. For example, the cooling system 336-1 can support the server 334 by cooling the server 334 during operation and/or execution of the workload 332. In some examples, the number of systems can include elements that support each corresponding system. For example, the cooling system 336-1 can include a liquid cooling system 338-1 and an air cooling system 338-2. In this example, the liquid cooling system 338-1 can include a coolant pump 340-1, a vacuum pump 340-2, and/or a temperature sensor 340-3 to provide liquid cooling to the server 334. In addition, the air cooling system 338-2 can include elements that support the air cooling system 338-2. For example, the air cooling system 338-2 can include, but is not limited to: fans 342-1, heat exchangers 342-2, rack fans 342-3, and/or air temperature sensors 342-2.

The support infrastructure elements of the cooling system 336-1 can be discovered by a number of discovery processes as described herein. In some examples, the fault representation can be organized as a data tree where elements on a higher level are dependent on elements connected on a lower level. For example, the functionality of the liquid cooling system 338-1 can be dependent on the coolant pump 340-1, the vacuum pump 340-2, and/or the liquid temperature sensor 340-3 being functional.

The fault representation 330 can also include a visual display of each of the elements within the support infrastructure to represent a real-time functionality of each of the elements. For example, the visual display of each of the elements can include a visual color display to represent the real-time functionality of a corresponding element. In some examples, the real-time functionality can be based on monitored data associated with the element and/or a dependency relationship with other elements. For example, the real-time functionality of the coolant pump 340-1 can be based on monitored data (e.g., flow rate, pump speed, pressure drop, etc.) related to the coolant pump 340-1. In this example, the real-time functionality of the liquid cooling system 338-1 can be based in part on the real-time functionality of the coolant pump 340-1. That is, when the coolant pump 340-1 is not functioning to the specification of the coolant pump 340-1, the real-time functionality of the liquid cooling system 338-1 can be affected. Thus, in this example, the visual display of the coolant pump 340-1 can be identified (e.g., color coded, highlighted, etc.) as not functioning or not functioning at an optimal level and the liquid cooling system 338-1 can be identified (e.g., color coded, highlighted, etc.) as having a relatively higher probability of failure due to the coolant pump 340-1.

In some examples, the visual display of the number of elements of the fault representation 330 can be color coded to represent the real-time functionality of each of the number of elements. For example, elements that are functioning properly (e.g., functioning to expectations, functioning to specifications defined by a manufacturer, etc.) can be color coded in green. In this example, elements that are functioning outside a first threshold value can be color coded in yellow to represent that there is a possibility of a malfunction or that the element may have a relatively higher probability of a malfunction. Further in this example, elements that have failed can be color coded in red to alert a user that the elements have failed. As described herein, the elements on a lower level can affect the functionality of elements on a higher level when the elements are connected. For example, a fan 342-1 can be displayed in red or yellow to identify that the fan 342-1 is not functioning properly. In this example, the air cooling system 338-2 and/or the cooling system 336-1 may also be color coded in yellow or red to identify that the air cooling system 338-2 and/or the cooling system 336-1 may have a relatively higher probability of malfunctioning or not being able to provide sufficient cooling resources to the server 334.

The fault representation 330 can be utilized to display an overall health and/or probability of failure for a computing system such as a server 334 to execute a workload 332. The fault representation 330 can be displayed with a color coded visual display to identify potential malfunctions and/or a probability that a computing device such as a server 334 can successfully execute the workload 332 without a malfunction. The fault representation 330 can be generated by a number of discovery processes as described further herein. In some examples, the number of discovery processes can by updated periodically so that the fault representation 330 is current and up to date with the latest health score for each of the computing components of the computing infrastructure. Since the health score for each element utilizes a health score of neighboring elements or elements with a particular relationship, the fault representation 330 can display a reliability of a plurality of hardware to determine the most reliable hardware for executing a workload 332.

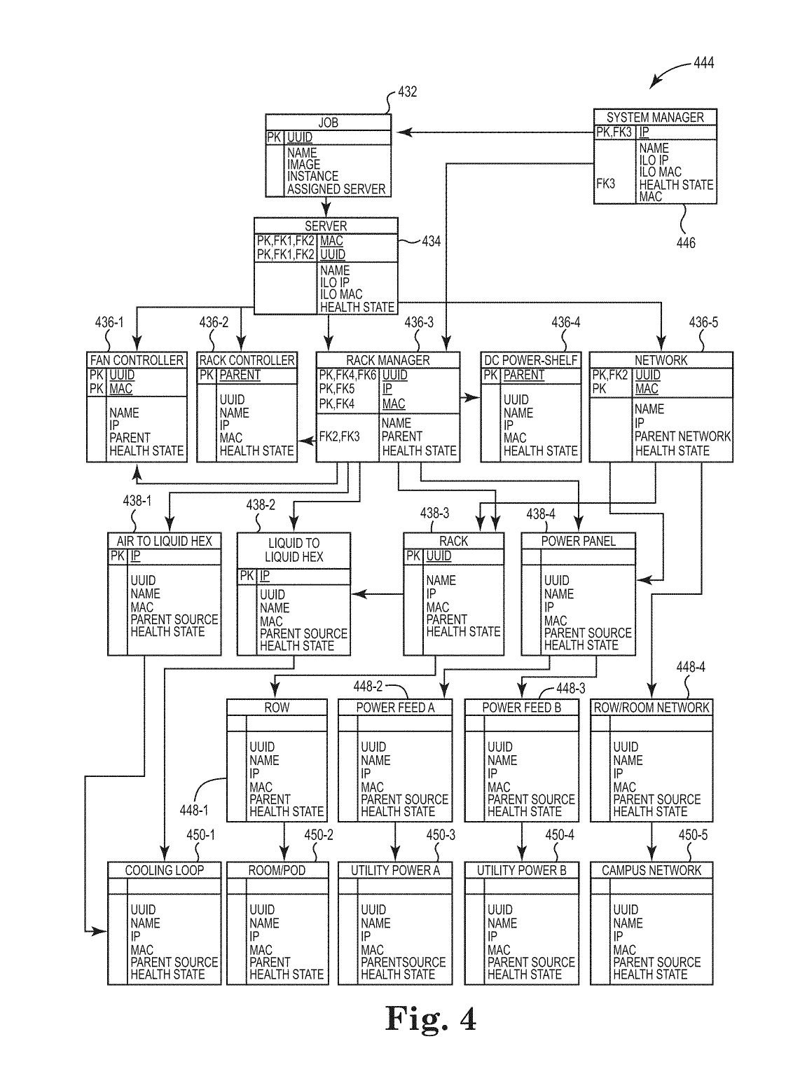

FIG. 4 illustrates a diagram of an example display of a fault representation 444 of a computing infrastructure consistent with the present disclosure. The fault representation 444 can represent a more detailed version of fault representation 330 as referenced in FIG. 3. That is, the fault representation 444 can include additional details regarding the respective elements of the system compared to fault representation 330 as referenced in FIG. 3. In some examples, the additional details can displayed upon selection of an element and/or upon detection of a failure of a particular element. That is, in some examples, the fault representation 444 can be a representation of the additional details associated with each element of fault representation 330 as referenced in FIG. 3.

The additional details can include detailed information corresponding to each element of the computing infrastructure. For example, the additional details can include specification information relating to each element of the computing infrastructure. The specification information can include, but is not limited to: part number, MAC address, IP address, integrated lights out (iLO) IP address, iLO MAC address, health state, generic name, among other information to describe the corresponding element.

As described herein, the fault representation 444 can be generated based on information collected through a number of discovery processes described herein. The number of discovery processes can also be utilized to define relationships between each of the elements and how the relationships can affect other elements within the computing infrastructure. In some examples, the discovery processes can define a number of supporting infrastructures of a system and generating a directional graph representation for each of a plurality of supporting infrastructures. As described herein, the plurality of supporting infrastructures can be combined to form a fault representation 330 as referenced in FIG. 3 and/or a fault representation 444.

In some examples, the fault representation 444 can utilize a job 432 (e.g., workload, etc.) as a root node to determine whether the job can be executed by the computing system without failure of the computing system. The number of discovery processes can determine which computing device such as a server 434 is utilized to execute the job 432. In some examples, a system manager 446 can be identified by a discovery process and also act as a possible root node of the fault representation 444. Although the job 432 and/or system manager 446 are utilized as a root node in these examples, the fault representation 444 can utilize any of the displayed elements as a root node to identify particular issues with a particular element.

The server 434 can include a support infrastructure that can have an impact on the server's 434 functionality and/or ability to execute the job 432. The support infrastructure can include hardware elements, software elements, and/or virtual elements that support the server 434. In some examples, the server 434 can be directly connected to a number of elements that are most closely related to the functionality of the server 434. For example, the server 434 can be directly connected to a fan controller 436-1, rack controller 436-2, a rack manager 436-3, power shelf 436-4 (e.g., direct current (DC) power shelf, etc.), and a network system 436-5.

In some examples, the discovery processes described herein can be utilized to determine a number of elements with a relationship to the rack manager 436-3. For example, the number of elements with a relationship to the rack manager 436-3 can include, but are not limited to: an air to liquid heat exchanger (HEX) 438-1, a liquid to liquid HEX 438-2, a rack 438-3, and/or a power panel 438-4. In some examples, each of the number of elements can have additional elements with a relationship to each of the corresponding elements. For example, the air to liquid HEX 438-1 can include a cooling loop 450-1 that can have a relationship with the air to liquid HEX 438-1. In addition, the rack 438-3 can include a row 448-1 and a room 450-2 that can also affect the functionality of the rack 438-2. In some examples, the power panel 438-4 can include a number of power feeds 448-2, 448-3 and/or a number of utility power sources 450-3, 450-4.

In some examples, an element can be connected to elements that are also connected to other elements on the same or similar level of the fault representation 444. For example, the power panel 438-3 can be connected to the rack manager 436-3 as well as the network 436-5. In this example, the power panel 438-3 can affect the functionality and/or performance of the rack manager 436-3 and the network 436-5. Thus, a malfunction of the power panel 438-3 can affect a functionality of the rack manager 436-3 and/or the network 436-5. In some examples, the network 436-5 can be connected to the power panel 438-3 and also connected to elements on a lower level than the power panel 438-3 such as a row/room network 448-4 and a campus network 450-5.

As described herein, the fault representation 444 can be generated by a number of discovery processes as described further herein. The fault representation 444 can be displayed with a color coded visual display to identify potential malfunctions and/or a probability that a computing device such as a server 434 can successfully execute the job 432 without a malfunction. In some examples, the fault representation can display a health score of each element as well as a health score of the overall infrastructure. The health score of the overall infrastructure can represent a reliability of the computing hardware and can provide information for executing a workload on the most reliable hardware of the infrastructure.

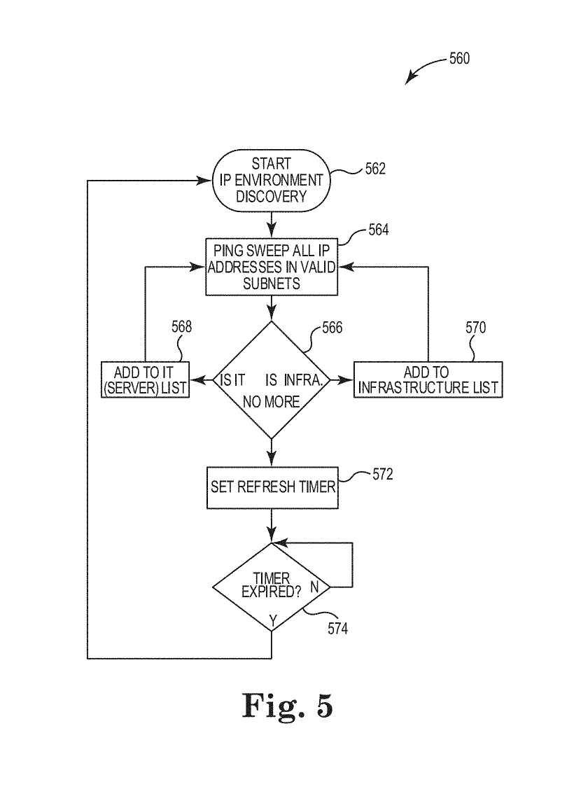

FIG. 5 illustrates a flow chart of an example of a method 560 for environment discovery for fault representation of computing infrastructures consistent with the present disclosure. The method 560 can be utilized to discover elements of an IP infrastructure for a fault representation as described herein. The method 560 can begin at 562. The method 560 can include a ping sweep of IP addresses in a valid subnet at 564. The ping sweep can include sending a signal to a number of devices and receiving a response from the number of devices. In some examples, the response from the number of devices can be utilized to identify whether the corresponding device of the response is an IT server device or part of a support infrastructure at 566.

At 566 the method 560 can separate the IT server devices at 568 from support infrastructure elements at 570. As described herein, the support infrastructure elements can include elements that support a computing device such as a server. The support infrastructure elements can include, but are not limited to: cooling systems, power systems, and/or network systems. When there are no additional messages received from devices, the method 560 can set a refresh timer at 572. The refresh timer can set a quantity of time for scheduling the method 560 to begin again at 562. At 574, the method 560 can determine whether the timer has expired. When the timer has expired the method 560 can begin again at 562.

The method 560 can be utilized to identify elements of a computing infrastructure that include an IP address, MAC address, or other type of networking address. In some examples, a number of servers can be identified via method 560 and a number of supporting elements can be identified and separated into a supporting element category. In some examples, the method 560 can be utilized to assign the supporting elements to a particular computing device such as a server.

FIG. 6 illustrates a flow chart of an example of a method 676 for infrastructure discovery for fault representation of computing infrastructures consistent with the present disclosure. Method 676 can be utilized to discover elements and relationships between elements for the fault representation as described herein. The method 676 can start a relationship discovery at 678. In some examples, the method 676 can include polling an infrastructure node from a node list (e.g., discovered elements from method 560, etc.).

In some examples, the method 676 can query a number of devices of a computing system to determine relationships within a plurality of different computing systems based on meta-data and/or relationship data that is stored by each of the of devices of the computing system. In some examples, the method 676 can determine relationships based on how a first number of components are affected by altering settings of a second number of components. For example, the method 676 can utilize pulsing of a cooling system to see how heat from a first number of components affects the cooling of a second number of components.

In some examples, the method 676 can determine if the node is a system manager at 682-1. If the node is a system manager, the method 676 can evaluate the system manager through a number of relationship processes 684 to determine a number of associations (e.g., relationships, etc.). If the node is a system manager, the relationship processes can include, but are not limited to: determine associated jobs or workloads, determine associated servers, determine associated AMP, and/or determine network dependencies. In some examples, the relationship processes 684 can end by storing the associations in a database for generating a fault representation as described herein.

In some examples, the method 676 can determine that the node is not a system manager. In these examples, the method 676 can determine if the node is an rack manager at 682-2. If the node is a rack manager, the method 676 can evaluate the rack manager through a number of relationship processes 684. In some examples, the relationship processes 684 for a rack manager can include, but are not limited to: determine associated fan controller, determine associated rack controller, determine associated intelligent coolant distribution unit (iCDU), and/or determine associated power shelf (e.g., high voltage direct current (HVDC) power shelf, etc.). In addition, the relationship processes 684 can end by storing the associations in a database for generating a fault representation as described herein.

In some examples, the method 676 can determine that a node is not a system manager or a rack manager. In these examples, the method 676 can determine if the node is network infrastructure at 682-3. If the node is network infrastructure, the method 676 can evaluate the network infrastructure through a number of relationship processes 684. In some examples, the relationship processes 684 for network infrastructure can include, but is not limited to determining associated parent networks. In addition, the relationship processes 684 can end by storing the associations in a database for generating a fault representation as described herein.

In some examples, the method 676 can determine that a node is not a system manager, a rack manager, or network infrastructure. In these examples the method can determine a device type of the element, determine associated devices based on the device type and device profile of the element. In addition, the device type and associated devices of the element can be stored in a database for generating a fault representation as described herein.

After the relationship processes 684 are complete, the method 676 can determine a number of inter-relationships at 689 between each of the systems relating to the system manager, rack manager, and/or network infrastructure, as well as other systems relating to other devices. In some examples, the number of inter-relationships can be determined at 689 based on local neighbor data. In some examples, the local neighbor data can be based on meta-data associated with components of the computing system. In some examples, the local neighbor data can be based on a number of indirect relationships. For example, the number of indirect relationships can be based on disturbance data via a number of disturbance tests.

In some examples, the number of disturbance tests can be performed to determine how one element or computing component affects another element or computing component. For example, a disturbance test can include an air cooling test to determine how heat from a first computing component affects the air temperature of cold air provided to a second computing component. In this example, the disturbance test can determine how the first computing component and the second computing component are related, even though there may be no meta-data associated with the particular relationship.

The method 676 can determine if there are additional nodes within the computing infrastructure at 686. When there are no additional nodes available the method 676 can set a refresh timer at 688 and determine when the timer has expired at 690. When the timer has expired, the method 676 can restart at 678. By utilizing a timer at 688, the fault representation as described herein can be continually updated to reflect new hardware added and/or hardware that has been replaced or removed.

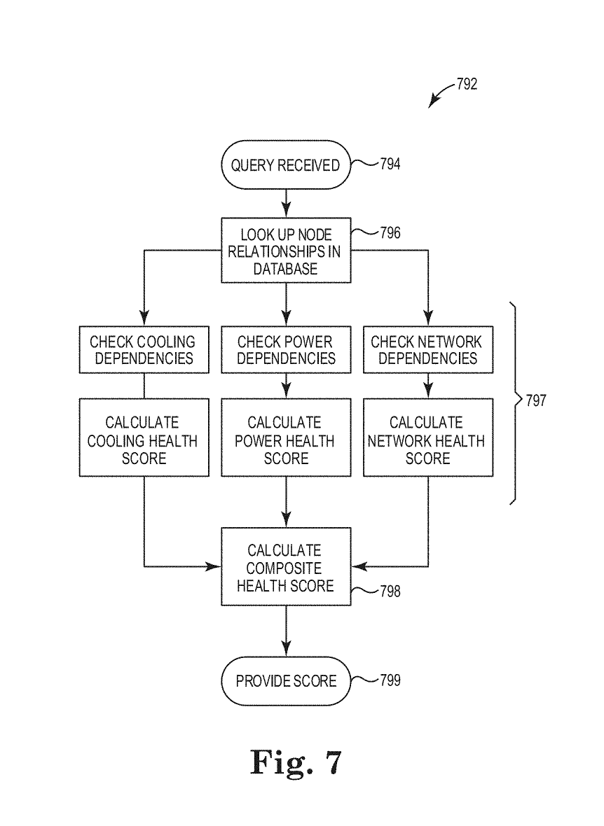

FIG. 7 illustrates a flow chart of an example of a method 792 for node health discovery for fault representation of computing infrastructures consistent with the present disclosure. The method 792 can be utilized to determine a health of an element and/or node within the fault representation. As described herein, each element of the fault representation can include a risk score and/or a health score. The risk score and/or health score can be a value that represents a health and/or likelihood of failure for a particular element and/or node of the fault representation. Since the elements of the fault representation have other elements that are related and can potentially affect the functionality of other elements, it is important to calculate how the risk score or health score of a first element affects the risk score and/or health score of a second element.

The method 792 can begin with a query being received at 794. The query can include a health status request for elements of the fault representation. The received query can include monitored data of a number of elements. The monitored data can be utilized to determine an independent health score for each element. With the independent health score for each individual element, the method 792 can determine node relationships at 796. In some examples, the node relationships are determined by method 676 as referenced in FIG. 6.

The method 792 can utilize the monitored data and node relationships to check dependencies and calculate a health score and/or a risk score for each element at 797. In some examples, the method 792 can include: checking cooling dependencies to calculate a cooling health score; checking power dependencies to calculate a power health score; and/or checking network dependencies to calculate a network health score at 797.

In some examples, the cooling health score, power health score, and/or network health score can be utilized to calculate a composite health score for each element and/or the overall computing system. In some examples, the composite health score can include a value that represents a likelihood of a computing system to successfully execute a workload without a failure of the computing system. In some examples, the composite health score can be provided to a user at 799.

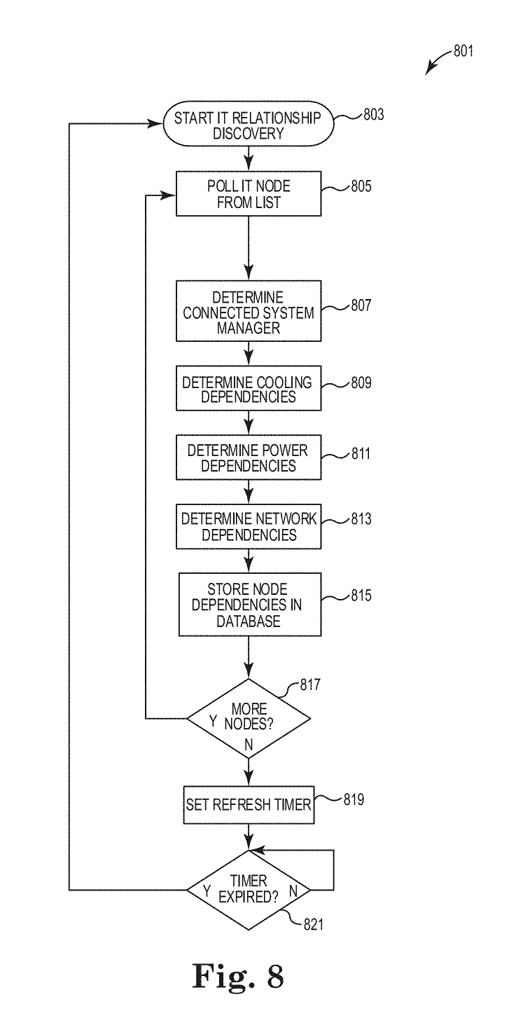

FIG. 8 illustrates a flow chart of an example of a method 801 for node relationship discovery for fault representation of computing infrastructures consistent with the present disclosure. The method 801 can be utilized to discover dependencies for each of a plurality of computing devices such as servers. The method 801 can be utilized to discover the support infrastructure for a server to generate a fault representation as described herein.

The method 801 can start at 803. At 805, the method 801 can include polling IT nodes from a list. In some examples, the list can be a stored list that was generated by one of the discovery processes described herein. Polling the list can include sending a message or signal to a number of nodes within a computing infrastructure and based on a response from the number of nodes information can be determined.

At 807, the method 801 can include determining a connected system manager for the particular computing device such as a server. That is, a particular server can be coupled to a particular system manager. At 807, the method 801 determines which of the identified system managers of a computing infrastructure are connected to a particular server that is polled at 805.

At 809, the method 801 can determine cooling dependencies of the computing device that is polled at 805. In some examples, the cooling dependencies can include a plurality of elements that provide cooling resources to the computing device. For example, a particular server can include a liquid cooling system with a number of elements as well as an air cooling system with a number of elements.

At 811, the method 801 can determine power dependencies associated with the computing device that is polled at 805. In some examples, the power dependencies can include a plurality of elements that provide electrical power to the computing device. In some examples, the power dependencies can include information relating to redundancy requirements. In these examples, a number of elements can be redundant and therefore continue to provide sufficient power to the computing device even when a number of the elements are not functioning properly. In these examples, the redundancy requirements can be important in determining a risk score and/or health score of the power dependencies.

At 813, the method 801 can determine network dependencies. In some examples, the network dependencies can include a plurality of elements that provide network connection to the computing device polled at 805. In some examples, the network dependencies can include a plurality of elements to provide a network connection to a server. In some examples, the network dependencies can have a number of elements in common with the power dependencies as described herein. At 815, the method 801 can store node dependencies in a database for generating a fault representation as described herein. In addition, at 817, the method can determine if there are additional nodes to discover. When there are additional nodes to discover the method 801 can return to 803 to start IT relationship discovery. At 819 a refresh timer can be set to restart the method 801 at a later time as described herein. At 821, the method 801 can include determining when the timer has expired. As described herein, when it is determined that the timer has expired, the method 801 can return to the start at 803.

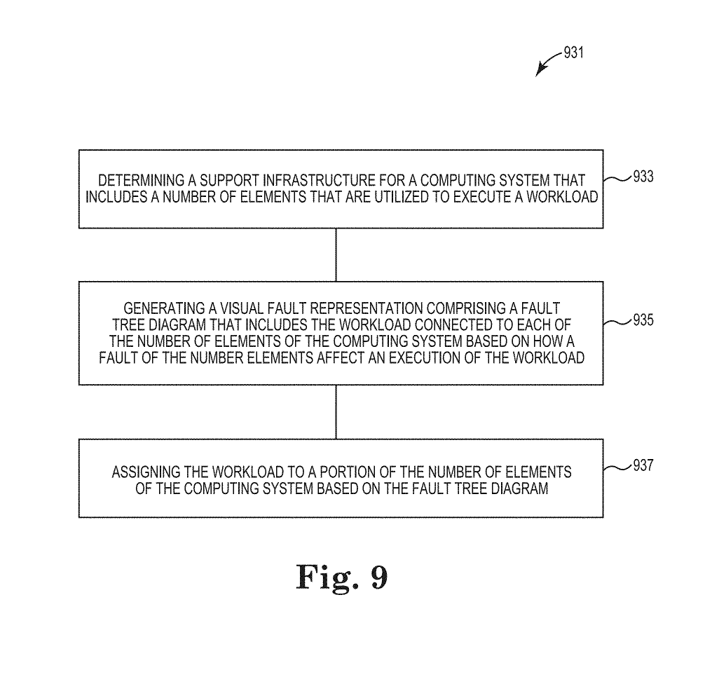

FIG. 9 illustrates a flow chart of an example of a method 931 for fault representation of computing infrastructures consistent with the present disclosure. The method 931 can be executed by a system (e.g., system 100 as referenced in FIG. 1) and/or a computing device (e.g., computing device 214 as referenced in FIG. 2). As described herein, the method 931 can be utilized to generate a fault representation and/or to determine a computing device such as a server to execute a load. In some examples, the fault representation can provide a visual representation of a number of server nodes with corresponding support structure to view an overall health and/or overall risk of the server node and corresponding support structure.

At 933, the method 931 can include determining a support infrastructure for a computing system that includes a number of elements that are utilized to execute a workload. As described herein, the support infrastructure can include, but is not limited to: cooling systems, power systems, and/or network systems that support a computing device such as server. Determining the support infrastructure can include utilizing a number of discovery processes as described herein to discover elements of a support infrastructure for a corresponding computing device.

At 935, the method 931 can include generating a visual fault representation comprising a fault tree diagram that includes the workload connected to each of the number of elements of the computing system based on how a fault of the number elements affect an execution of the workload. As described herein, the visual fault representation can be organized as a fault tree diagram with a workload and/or job designated as a root node. In addition, a plurality of elements can be connected to the workload based on how closely related or associated the elements are with the execution of the workload. These relationships and/or associations can be determined through a number of discovery processes as described herein to determine a location on the fault tree diagram for each of the plurality of elements.

At 937, the method 931 can include assigning the workload to a portion of the number of elements of the computing system based on the fault tree diagram. Assigning the workload to a portion of the number of elements of the computing system can include assigning the workload to a particular server with a particular number of supporting elements based on a risk score and/or health score associated with the particular number of supporting elements. As described herein, the fault representation and/or fault tree diagram can be utilized to quickly view a computing system infrastructure to determine potential failures of the computing infrastructure.

As used herein, “logic” is an alternative or additional processing resource to perform a particular action and/or function, etc., described herein, which includes hardware, e.g., various forms of transistor logic, application specific integrated circuits (ASICs), etc., as opposed to computer executable instructions, e.g., software firmware, etc., stored in memory and executable by a processor. Further, as used herein, “a” or “a number of” something can refer to one or more such things. For example, “a number of widgets” can refer to one or more widgets.

The above specification, examples and data provide a description of the method and applications, and use of the system and method of the present disclosure. Since many examples can be made without departing from the spirit and scope of the system and method of the present disclosure, this specification merely sets forth some of the many possible example configurations and implementations.

What is claimed:

1. A system for fault representation of computing infrastructures, comprising:
an infrastructure engine to determine a fault relationship between a first element and a second element within a computing infrastructure, wherein the fault relationship represents an ability of the first element and the second element to function;
a representation engine to generate a fault representation of the computing infrastructure based on the determined fault relationship between the first element and the second element within the computing infrastructure; and
a workload engine to assign workloads to the computing infrastructure based on the fault representation of the computing infrastructure.

2. The system of claim 1, wherein the representation engine assigns a risk score to a plurality of elements that include the first element and the second element based on the fault relationship.

3. The system of claim 2, wherein the risk score is a value that represents a possibility of direct and indirect failure of a corresponding element.

4. The system of claim 1, wherein the fault representation of the computing infrastructure includes a visual representation of the first element and the second element in a tree structure.

5. The system of claim 4, wherein the visual representation of the first element and the second element are selectable to display operational parameters and diagnostic information of the corresponding element.

6. The system of claim 1, wherein the representation includes a visual representation of functionality for the first element and the second element based on real-time data.

7. The system of claim 6, wherein the visual representation of functionality for the first element is based on a probability of failure for the first element and a probability of failure for the second element, wherein a functionality of the first element is dependent on the second element.

8. A non-transitory computer readable medium storing instructions executable by a processor for fault representation of computing infrastructures, wherein the instructions are executable to:
determine a support infrastructure for a computing system that includes a number of elements that are utilized to provide functionality to the computing system;
generate a visual representation of a fault representation that includes the computing system connected to each of the number of elements based on how the number elements provide functionality to the computing system; and
assign workloads to the computing system based on the fault representation.

9. The medium of claim 8, wherein the visual representation of the fault representation is organized to connect each of the number of elements to the computing device based on how the number of elements affect a functionality of the computing device.

10. The medium of claim 8, wherein the number of elements include physical devices and virtual machines that provide the computing device a functionality to execute the workloads.

11. The medium of claim 8, wherein the fault representation is a fault tree diagram that includes a workload as a root node.

12. A method for fault representation of computing infrastructures, comprising:
determining a support infrastructure for a computing system that includes a number of elements that are utilized to execute a workload;
generating a visual fault representation comprising a fault tree diagram that includes the workload connected to each of the number of elements of the computing system based on how a fault of the number elements affect an execution of the workload; and
assigning the workload to a portion of the number of elements of the computing system based on the fault tree diagram.

13. The method of claim 12, wherein assigning the workload includes determining a probability of a fault for each of the portion of the number of elements.

14. The method of claim 12, comprising selecting a particular element from the number of elements to display a detailed diagram of the particular element.

15. The method of claim 14, wherein the detailed diagram includes real-time data corresponding to the particular element.
